(19) United States
(12) Patent Application Publication
(10) Pub. No.: US 2021/0370545 A1
(43) Pub. Date: Dec. 2, 2021

(54) Device and Method of Log Splitter Transportation

(71) Applicants: Steven Vanderburgh, Golden, CO (US); Feng Zhu, Jiahsan Zhejiang (CN)

(72) Inventors: Steven Vanderburgh, Golden, CO (US); Feng Zhu, Jiahsan Zhejiang (CN)

(21) Appl. No.: 16/889,519

(22) Filed: Jun. 1, 2020

(51) Int. Cl. B27L 7/06; B65D 85/68

(52) U.S. Cl. CPC B27L 7/06; B65D 85/68

(57) ABSTRACT

A custom bracket hinge which is used a single time during assembly of the log splitter, and a customized shipment stand allow an extremely quick and safe method of swinging two heavy parts of a log splitter trailer together, without lifting either part off of the ground until they are mated and can be swung into position. The first method aspect of the invention consists of the use of the special equipment (double hinge bracket mechanism and stand) to assemble the log splitter in a very small number of steps. The second method aspect of the invention is shipping the log splitter with the equipment, in a much smaller footprint.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but reserves all copyright rights whatsoever. 37 CFR 1.71(d).

### CROSS-REFERENCE TO RELATED APPLICATIONS

N/A

### FIELD OF THE INVENTION

This invention relates generally to log splitters and specifically to devices and methods for compact and economical transportation of multiple log splitters.

### STATEMENT REGARDING FEDERALLY FUNDED RESEARCH

This invention was not made under contract with an agency of the US Government, nor by any agency of the US Government.

### BACKGROUND OF THE INVENTION

A log splitter must have certain structural elements: the wood splitter beam is a strong and solid transverse member, an end plate against which wood is compressed, a hitch tongue assembly allowing the wood splitter to be towed behind a vehicle, road-worthy wheels, an engine to power the compression, a fuel tank and more.

However, the disparate and varied shape of these components results in shipping problems for these devices. Since each unit, when properly assembled, is the size of a small trailer, it is difficult to fit any significant number into any standard shipping footprint such as a container, a pallet, a truck or carriage. FIG. 1 is a planform view of a PRIOR ART footprint of a log splitter. As can be seen, it is not just the large size but the awkward shape which causes each unit to take up a large amount of cargo capacity.

One obvious solution would be disassembly of each log splitter, followed by assembly at the destination, usually a sales center. This is in fact commonly done, with the result that each log splitter requires around 30 to 45 minutes of assembly time. This is deemed too long by most retailers and can be dangerous, because it might not have been disassembled properly, to leave dangerous conditions. As a result of this, sellers have attempted compromises involving turning the log splitter upright. This shrinks the footprint of the individual log splitter a great deal. FIG. 2 is a planform view of a PRIOR ART footprint of a log splitter if rotated upright. The first problem is that the rear end of the log splitter extends past the wheels and so the wheels leave the ground and the entire device, which is extremely heavy (the horizontal beam by itself weighs several hundred pounds due to being made of heavy gauge metal, not to mention the weight of the hydraulic cylinder, the engine, etc.), must balance on a small projection such as the end plate or the like. This is too dangerous. In addition, the log splitter remains an awkward shape, unsuitable for logical packing into a cargo container or truck.

Other possible methods include detaching parts of the log splitter and for reassembly, running the wheels of the log splitter up a ramp to get one very heavy part of the log splitter elevated to match another one. This is awkward, requires a great deal of heft due to the weight of the main components of the log splitter, and is somewhat dangerous as well.

A wood splitter is a kind of agricultural and forestry machinery, its structure is relatively complex, and the shape and size after installation are irregular, which is not conducive to transportation. It normally must be assembled by the users after receiving the goods. Due to its large weight and volume, the installation is extremely inconvenient. Previously, there was no good loading structure that can guarantee the safety of transportation and good assembly performance at an economical shipping basis.

It would be preferable to provide a method of compact shipment of log splitters which allows safe transport in a compact footprint.

It would further be preferable to provide a method of compact shipment of log splitters which can save over a very substantial amount of money in shipping costs on a volume of less than one thousand log splitters and yet providing an assembly time of less than 10 minutes.

It would further be preferable to provide devices enabling compact shipment of log splitters with safety.

It would further be preferable to provide devices enabling speedy reassembly of log splitters in under 10 minutes per log splitter after shipment.

All of these advantages and more will be discussed further below.

### SUMMARY OF THE INVENTION

General Summary

The present invention teaches a kit and method for safe, compact shipment of log splitters.

The device of the invention consists of two parts, the first part being a custom off-axis hinge bracket which is used a single time during assembly of the log splitter, thereby allowing an extremely quick and safe method of swinging two very heavy parts of the log splitter trailer together, without lifting either part off of the ground until they are mated and can be swung into position. The second part of the invention is a customized stand for shipment, which keeps the log splitter safely upright and elevated so that one or both wheels may remain off the ground during shipping.

The first method aspect of the invention consists of the use of the special equipment (off-axis hinge bracket mechanism and specialized stand) to assemble the log splitter in a small number of steps and a short time.

The second method aspect of the invention is shipping the log splitter with the equipment, in a much smaller footprint.

In order to solve the above mentioned problems, a rapid loading stand for a wood splitter is provided, which has the advantages of low cost and convenient operation, and it can effectively coordinate with the structure of wood splitter, and ensure stability of transportation.

The rapid loading rack for the wood splitter comprises a symmetrically set B-shaped stand with connected side members providing vertical support. The upper end of the vertical side members are higher than the upper cross-bars of the B-shaped stand. The side members are connected to the upper ends of the vertical side members. The lower undersurface of a middle part of the first side member on one side is connected with a U-shaped frame which extends downward slightly. One end of the U-shaped frame is connected to the side member, and the other end is extended into the support stand and connected to the inner transverse member. The two ends of the inner member are connected with the upper undersurface of the upper cross-bar of B-shaped stand on both sides. The connection between the inner member and the upper cross-bar is by means of two short vertical members.

The side members at both sides are equipped with vertical limit stop plates.

The inner member set on the end of the upper cross-bar of B-shaped stand is connected with a small stop member. One end of the stop member is connected with the inner member, and the other end is connected with the upper cross-bar. The inner member, small stop member and upper undersurface of side member are all on the same plane; and the heights of the raised portion at both ends of the U-shaped frame, short vertical member and vertical side member above the upper undersurface of upper cross-bar of B-shaped stand are consistent so as to form two different planes of support for parts of the log splitter, and both planes are parallel to the ground/floor the stand rests upon.

The limit stop plate is set at the position where the middle of the side member is offset to the small stop member; and a hole for a hold down plate is arranged on the side member and the inner member, and another hole for a hold down plate is located on a side close to the small stop member; finally another hole for a cotter pin/bolt/securing device is also provided on the outer side surface of the side members.

Thus, a wood splitter rapid loading stand for the wood splitter comprises the loading rack and wood splitter, and a hinge bracket as discussed previously, characterized in that the wood splitter beam is vertical; the wood splitter beam is set within the depression formed by the U-shaped frame, inner member and B-shaped stand, and the end plate of the wood splitter beam is limited and trapped in the depression by installing the hold down plate using the hole for the hold down plate; the tank (and box and hitch tongue) assembly of the wood splitter is then set on the plane formed by two side members. The side of one log splitter tank is in contact with the limit stop plate to prevent motion in that dimension, and the side end plate of the tank (and hitch tongue) assembly of wood splitter is fixed in the hole for the cotter pin/secure pin, preventing motion of these parts as well.

This results in a secure, unitary package for shipping, which has a planform barely larger than the shipping stand itself. Despite the unassembled nature of the log splitter, it can be removed from the rack and assembled in 5 or 10 minutes by one person, with a few seconds of assistance by a second person.

The rapid loading shipping stand, disassembled log splitter, and the special hinge bracket are specially designed for the special structure of wood splitter and the problems associated with shipment of the irregular shape of log splitters. The mechanical structure of the kit (bracket and stand) is simple, so it can be produced easily, but it can be matched with the completely installed wood splitter, and it can even be used to fix the wood splitter later, if required. It not only ensures the smallest volume of the wood splitter in the vertical state, but also ensures its stability in the transportation process, so that the product can be transported to the user in am almost completely pre-assembled condition and undamaged state.

Summary in Reference to Claims

It is therefore another aspect, advantage, objective and embodiment of the invention, in addition to those discussed previously, to provide a packaged log splitter comprising:

first and second wheels;

a tank assembly having a hitch tongue and a box member having first and second ends, the first wheel attached to the first end of the box member, the hitch tongue attached to the box member and extending therefrom at an angle of 90 degrees, the tank assembly having a top part;

the second wheel removably attached to the hitch tongue;

an engine attached to the tank assembly;

first and second attachment points on the tank assembly;

a log splitter beam assembly having a log splitter beam having first and second ends and an end plate attached to the first end, and further having a hydraulic cylinder attached to the second end, the log splitter beam having third and fourth attachment points on a bottom part, the log splitter beam assembly further having a top part;

a shipping stand having a plurality of vertical members, supporting first and second side members and first and second upper cross bars so as to form a generally rectangular shape, the tank assembly and the log splitter beam assembly supported upon the shipping stand with the first wheel extending beyond the first side member;

the tank assembly and the log splitter beam assembly supported elevated upon the shipping stand with their respective top parts adjoining;

a detachable mounting bracket removably secured to the packaged log splitter.

It is therefore another aspect, advantage, objective and embodiment of the invention, in addition to those discussed previously, to provide a packaged log splitter, wherein the shipping stand further comprises:

a third upper inner member disposed between the first and second upper side members, the first and second upper side members and the third upper inner member defining a first plane;

first and second short vertical members connecting the third upper inner member to the first and second cross bars;

a stop extending from a first end of the third upper inner member, in the first plane but parallel to and disposed above the first cross-bar, the stop attached to the first cross-bar;

the first and second cross-bars defining a second plane;

a U-shaped body attached at a first end to the first upper side member and at a second end to the third upper inner member, the U-shaped body disposed below the first upper side member and the third upper inner member in the second plane and thus co-planar with the first and second side bars;

first and second vertical limit stop plates disposed upon the respective first and second upper side members, the first and second vertical limit stop plates projecting upward;

the end plate of the log splitter beam assembly resting on the U-shaped member and in between the first upper side member and the third upper inner member;

the tank assembly resting upon the first and second upper side members and the third upper inner member with the box assembly against the first and second vertical limit stop plates.

It is therefore another aspect, advantage, objective and embodiment of the invention, in addition to those discussed previously, to provide a packaged log splitter further comprising:

first and second apertures passing horizontally through the first and second upper side members;

third and fourth apertures passing vertically through the first and second upper side members;

a fifth aperture passing vertically through the third upper inner member.

It is therefore yet another aspect, advantage, objective and embodiment of the invention, in addition to those discussed previously, to provide a packaged log splitter further comprising:

a hold down plate having a sixth aperture therethrough, the hold down plate secured to the third upper inner member by a fastener passing through both the hold down plate and the third upper inner member;

the end plate of the beam assembly removably fastened to the shipping stand by the hold down plate.

And t is therefore another aspect, advantage, objective and embodiment of the invention, in addition to those discussed previously, to provide a packaged log splitter, wherein the box assembly is removably attached to the shipping stand by a plurality of pins passing through first and second apertures of the first and second upper side members.

It is therefore yet another aspect, objective, advantage and embodiment of the invention, in addition to those discussed previously, to provide a packaged log splitter the detachable mounting bracket further comprising:

first and second apertures therethrough and a diagonal support;

the detachable mounting bracket and the first aperture of the detachable mounting bracket being dimensioned and configured to engage to the first attachment point on the bottom of the beam assembly by means of a second fastener passing through both the first attachment point and the first aperture of the detachable mounting bracket, when the tank assembly is detached from the shipping stand by removal of the plurality of pins and then removed from the shipping stand and brought adjacent to the bottom of the beam assembly;

the second aperture of the detachable mounting bracket being dimensioned and configured to act as a hinge allowing rotation of the bottom of the beam assembly downward to the top of the tank assembly when the detachable mounting bracket is engaged to the first attachment point on the bottom of the beam assembly;

the third and fourth attachment points on the bottom of the beam assembly being dimensioned and configured to engage respectively to the first and second attachment points on the top of the tank assembly.

It is therefore another aspect, advantage, objective and embodiment of the invention, in addition to those discussed previously, to provide a method of unpackaging and assembling the packaged log splitter, comprising the steps of:
i. Removing a packaging material from the packaged log splitter;
ii. Detaching the second wheel from the packaged log splitter and attaching it to the second end of the box assembly;
iii. Detaching the tank assembly from the shipping stand by removal of the plurality of pins;
iv. Rotating the tank assembly to a horizontal position, thus removing it from the stand;
v. Bringing the tank assembly adjacent to the bottom of the beam assembly;
vi. Securing the detachable mounting bracket to the bottom of the beam assembly;
vii. Removing the hold down plate; and
viii. Rotating the beam assembly down until the third and fourth attachment points on the beam assembly engage the first and second attachment points on the tank assembly.

### BRIEF DESCRIPTION OF THE DRAWINGS

FIG. 1 is a planform view of a PRIOR ART footprint of a log splitter.

FIG. 2 is a planform view of a PRIOR ART footprint of a log splitter if rotated upright.

FIG. 3 is an elevated perspective view of a first embodiment of the invention.

FIG. 4 is an elevated perspective view of a second embodiment of the invention.

FIG. 5 is an elevated perspective view of a third embodiment of the invention showing the hinge of the fourth embodiment attached to the log splitter.

FIG. 6 is a perspective view of the fourth embodiment of the invention, detached.

FIG. 7 is a side view of the fourth embodiment of the invention, detached.

FIG. 8 is a planform view of the footprint of a log splitter, ready for shipment according to the present invention.

FIG. 9 is an elevated oblique perspective view of the invention, completed.

FIG. 10 is an oblique perspective side-rear view of the invention, showing how the hitch/tank assembly will roll around the log splitter beam assembly during the process of un-boxing and assembly.

FIG. 11 is a flow chart of the steps of the method embodiment of the invention.

### INDEX TO REFERENCE NUMERALS

SHIPPING STAND
Shipping stand 1
Side member 2
Vertical side member 3
U-shaped frame 4
Inner member 5
Top aperture 6
End aperture 7
Vertical limit stop plate 8
Upper cross bar 9
Stop 10
Short vertical member 11
LOG SPLITTER
Log splitter beam 12
End plate 13
Detachable mounting bracket 14
Hold down plate 15
Tank assembly 16
Side end plate 17
Wheel 18
Attachment point 20
Pin 22
Second attachment point 24
Tongue 26
DETACHABLE MOUNTING BRACKET
Detachable mounting bracket 30
Flanges 32
Diagonal support 34
Apertures 36
STEPS
Direction of motion of hitch/tank assembly 100

### DETAILED DESCRIPTION

### Glossary

An off-axis hinge bracket is a bracket which has a hinge point which is not on the axis of the log splitter beam and extends beyond the end of the hitch tongue, and is thus not limited to being hinged at or even near to either of these two parts. By the use of this off-axis hinge bracket, the two major assemblies of the invention may be rotated into position together despite the fact that neither can be attached directly to the other.

A customized stand is defined to be a stand which supports on one portion a tank assembly, and on another part a log splitter beam assembly, with the two assemblies positioned back to back and unattached to one another, in a mutual relative orientation and position which does not allow proper attachment while in the packaged condition.

A box assembly functions as both a tank for fluid, and also as a structural axle (the trailer log splitter of the invention has no true axle, the wheels being independently fastened to the end plates 17 of the box assembly), and thus the box assembly serves multiple purposes and is not identified strictly as a tank or as an axle.

End Glossary

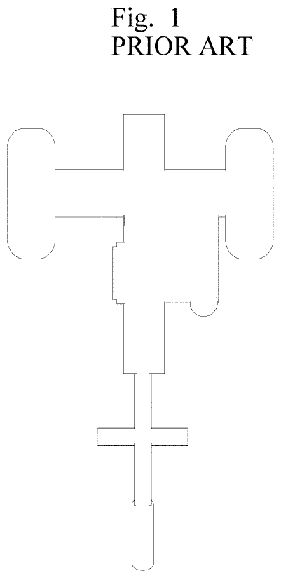

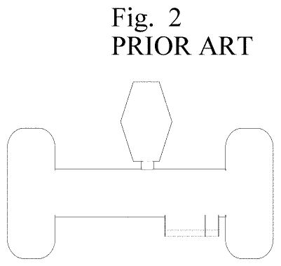

FIG. 1 is a planform view of a PRIOR ART footprint of a log splitter and FIG. 2 is a planform view of a PRIOR ART footprint of a log splitter if rotated upright. As discussed previously, these footprints are large and of awkward shapes, making for high shipping costs.

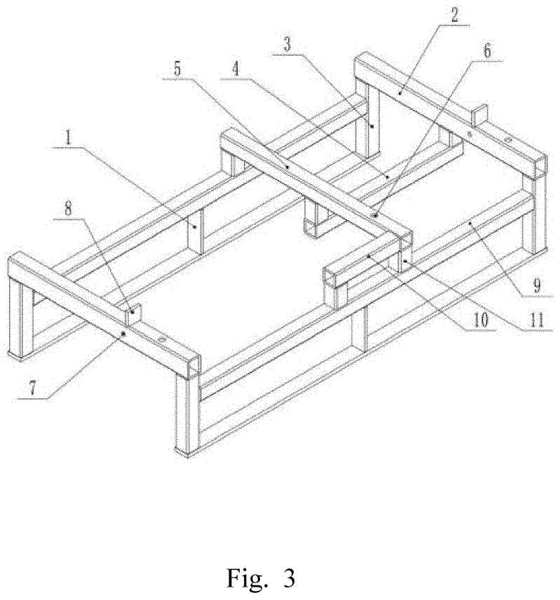

FIG. 3 is an elevated perspective view of a first embodiment of the invention, a shipping stand. While this stand would not normally fit a log splitter, if the log splitter is properly partially disassembled, the stand then holds the log splitter upright in a safe, balanced mode. Note that the stand by itself is not sufficient to provide for cheap, compact, transportation followed by safe, speedy assembly: the special bracket/hinge of the invention is also required for the present invention to function, as well as proper operations of assembly and disassembly. No one would actually ship an assembled log splitter upright due to the danger of the unstable configuration.

Shipping stand 1 is designed to sit on flat surfaces such as floors, loading docks, pavement, truck beds, shipping containers and so on, and it has a bottom for this.

Side members 2 (one at each end) define a first and higher plane. On these two upper side members 2 (and the upper inner member 5), the box assembly of the invention (the tank assembly's rear end) will sit.

Side members 2 and the other members of the stand may be made of any convenient and inexpensive material such as aluminum, other metal, wood, polymer and so on. Note that square box beams are pictured, but tubes, rods, flat members, rectangular box beams and other equivalents may be used.

Vertical side members 3 extend upward to the level of the side members 2. Since the various vertical members (6 are pictured, four of the box beam type and two which are flat members) must support the entire weight of the packaged log splitter, they must be strong.

U-shaped frame 4 is important, as is the location of inner member 5. These two parts define an aperture into which the end plate 13 of the log splitter beam 12 will sit. The U-shaped member is depicted to be below the level of the upper cross-bars 9, at which level U-shaped member, the cross-bars 9 and the side and inner upper bards (2 and 5) will trap the end plate 13, securing it in place for transport. Since the beam 12 is heavy, and has a large cylinder thereon, it is important that it not fall during transport.

Top aperture 6, end aperture 7 and other apertures allow the use of fasteners such as pins, cotter pins, bolts, and so on to secure parts of the log splitter to the shipping stand.

Vertical limit stop plate 8 is used to stop the motion of the box assembly (the hydraulic fluid/oil tank and substitute for an axle).

Upper cross bars 9 (two), define a second plane. This plane is lower than the plane defined by the upper side/inner members. In embodiments hypothetically the U-shaped member is in the same plane as bars 9.

Stop 10 also serves to prevent motion of the engine/motor of the device, for example, if a part such as a gas tank or the like is positioned against the stop 10.

Short vertical member 11 may be the same material as the rest of the device or in hypothetical embodiments may be an elastic material.

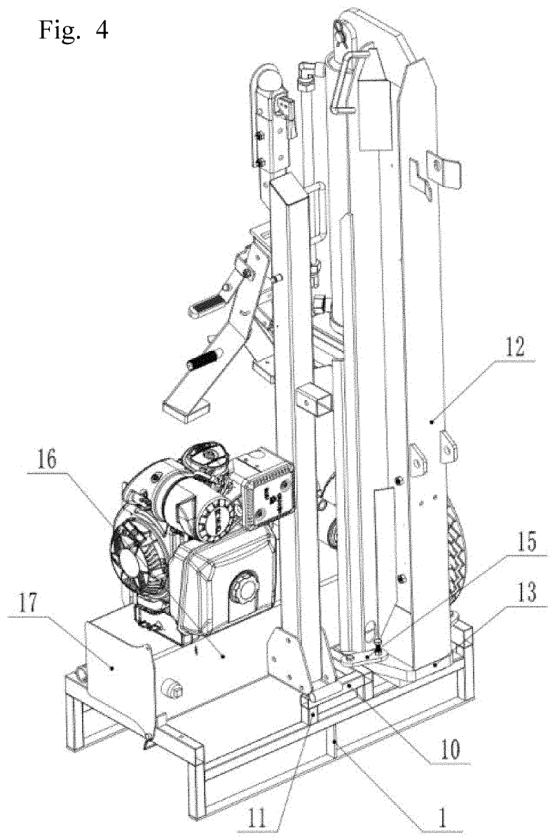

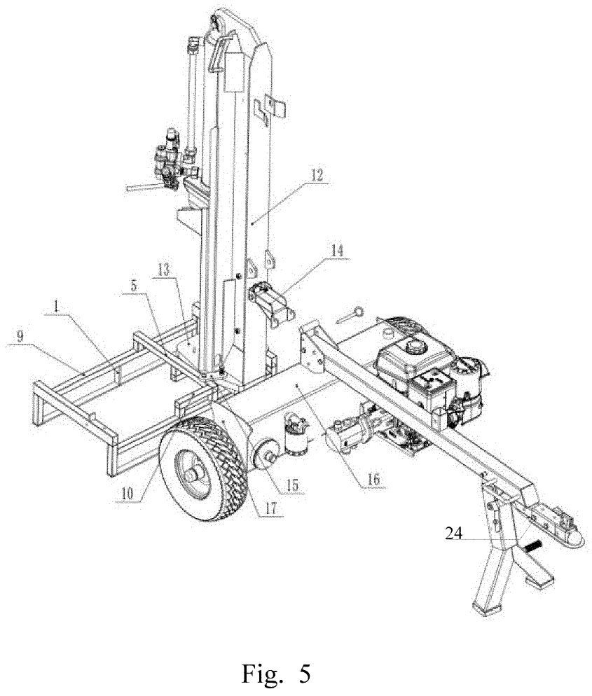

One important note is useful to keep in mind in looking at FIGS. 4 and 5. The stand as seen in FIG. 3 has two major assemblies thereon for shipping: the tank assembly and the beam assembly.

Now the beam assembly sits more or less on the “front” side as viewed in FIG. 3 (that, is, on the same side at which the numeral 9 is seen), while the box assembly sits on the “rear” side (as seen).

The two assemblies actually sit in a position in which they cannot be attached together. The top of the tank assembly sits against the top of the beam assembly. When the log splitter is put together, the BOTTOM of the beam assembly would attach to the top of the tank assembly. To assemble the device, a second wheel is added to the box assembly and it is rotated down off the stand 1, rolled around the stand 1 to the other side, and rotated 180 degrees so it is ready to receive the beam assembly, as shown by arrow 100.

FIG. 4 shows the log splitter on the stand with the tank assembly behind the beam assembly, but FIG. 5 shows it after the tank assembly has been removed and rolled around to the other side.

FIG. 4 is an elevated perspective view of a second embodiment of the invention, showing a packaged log splitter on the stand, partially disassembled.

As a preliminary matter, a second wheel is shipped attached to the packaged log splitter at a location above the engine. For clarity, the second wheel is shown removed. However, the first wheel (just partially visible behind beam 12) is shipped attached.

This means that the footprint of the log splitter has been reduced to a small rectangular shape with a wheel sticking out one side. This regular, compact shape is what allows the device to save substantial amounts of money every year on shipping costs for quantities of units. By the use of the special stand 1 and the detachable mounting bracket 14, as well as the proper sequence of assembly and packaging, it is furthermore possible to assemble the log splitter much FASTER than by known methods of packaging, meaning the log splitter is both cheaper to ship than if fully assembled and faster to finish assembly.

Log splitter beam 12 is vertical on the stand 1, with end plate 13 down on the stand. It will be seen that the log splitter beam 12 is quite heavy gauge material, heavy, and dangerous if it falls over. End plate 13 is attached by hold down plate 15 to the stand 1. Tank/tank assembly 16 and beam assembly 12 are both also secured by pins/cotter keys/bolts passing through the stand and parts of the log splitter such as side end plate 17.

Detachable mounting bracket 14 is not seen attached in this view, but is visible in FIG. 5.

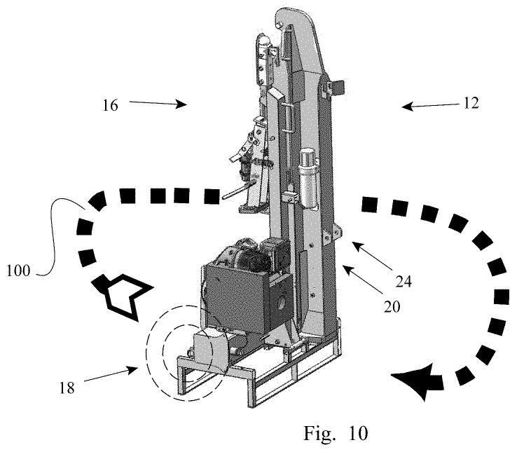

FIG. 5 is an elevated perspective view of a third embodiment of the invention showing the hinge of the fourth embodiment attached to the log splitter. Note that the tank assembly has been modified from FIG. 4, in particular, the second wheel has been attached (it is now partially visible behind the engine), and the tank/hitch assembly 16 has been rotated down to floor level and rolled around the stand 1 from the far side (FIG. 4) to the near side (FIG. 5) as shown by arrow 100 in FIG. 10.

Briefly referring to FIG. 10 (an oblique perspective side-rear view of the invention), which shows how the hitch/tank assembly will roll around the log splitter beam assembly (following arrow 100) during the process of un-boxing and assembly. Note that in addition to rolling the tank/hitch assembly around the shipping stand 1 (with the log splitter beam assembly 12 still upright thereon), the tank/hitch assembly 16 is also turned 180 degrees so that the top of the tank assembly 16 aligns with the bottom of the log splitter beam assembly 12.

Detachable mounting bracket 14 has now been attached in FIG. 5 to the beam 12. In practice, the user will next back up the tank assembly until the detachable mounting bracket 14 is lined up with the attachment point 20 in front of it. The pin 22 (floating by the attachment point) is then used to secure the detachable mounting bracket 14 to the tank/hitch tongue assembly 16 at the attachment point 20. At this point, the beam 12 is vertical on the stand but is attached by the temporary mounting bracket 14/attachment point 20 to the tank assembly 12.

The user then removes the hold down plate 15 and pins securing the beam 12 to the stand 1 and rotates the beam 12 down onto the tank assembly 16. Note that the axis of rotation will be a point which is not on the axis of the beam 12, nor is the axis of rotation within the length of the hitch: the rotation is about the pin 22 securing the aperture of bracket 14 to the beam. This location for the rotation being away from both of the two major assemblies is important for mating one to the other: the attachment point 20 on the bottom of the beam 12 (a pair of holes in this embodiment) and the second attachment point 24 (ears with holes) are dimensioned and configured to engage to the two attachment points seen on the top of the hitch, in this case with pins or fasteners or equivalents.

Once fastened together, the assembled log splitter no longer needs the temporary detachable mounting bracket 14 and it may be removed. The empty stand may also be removed.

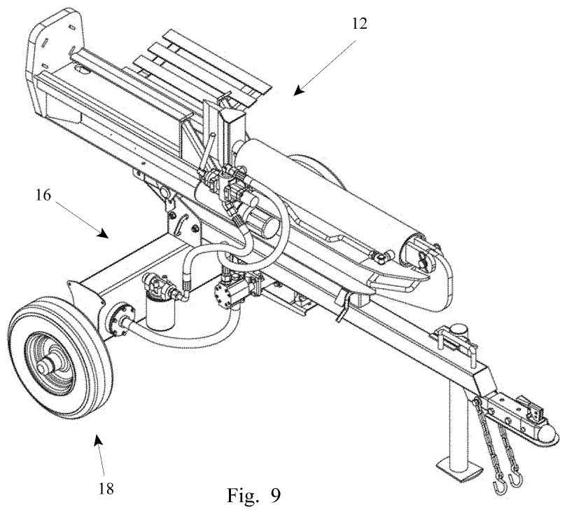

FIG. 9 is an elevated oblique perspective view of the invention, completed. The log splitter beam assembly 12 is now horizontal and atop the tank/hitch assembly 16 and fastened thereto.

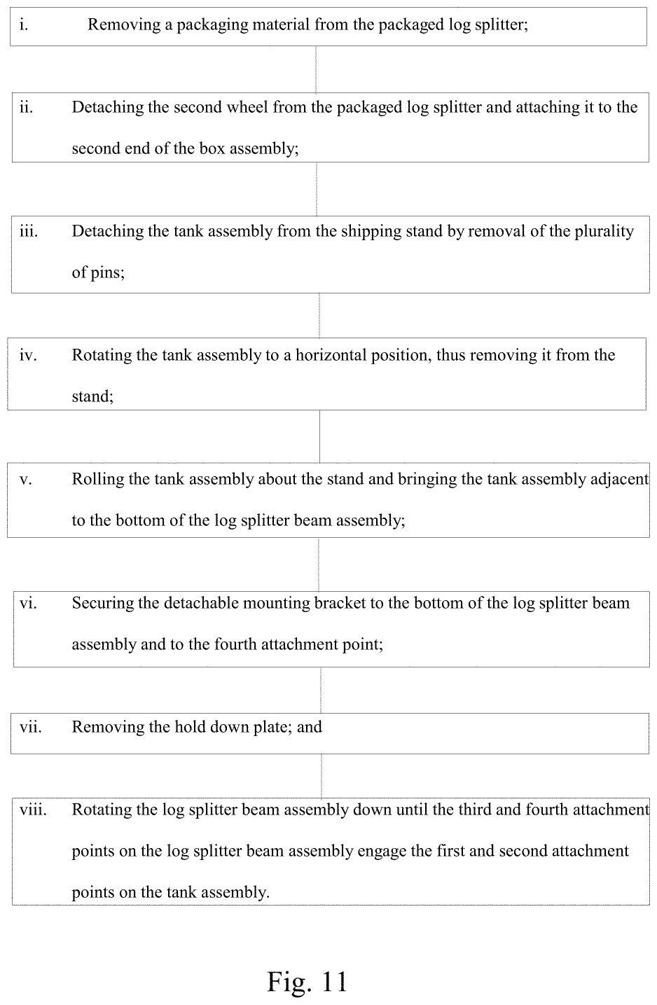

FIG. 11 is a flow chart of the steps of the method embodiment of the invention. The steps are as follows:
i. Removing the packaging material from the packaged log splitter as it stands vertically atop the stand, wrapped in the packaging material, which may be a polymer, a film, etc.
ii. Detaching the second wheel from the packaged log splitter (the wheel being separate from the hub during shipment) and attaching it to the second end of the box assembly. The first wheel is shipped attached at the first end of the box assembly.
iii. Detaching the tank assembly, which now has both wheels attached, from the shipping stand by removal of the plurality of pins.
iv. With both wheels on, it is possible to rotate the tank assembly to a horizontal position, bringing the wheels to the ground and thus removing it from the stand to the floor.
v. Rolling the tank assembly around the stand and bringing the tank assembly adjacent to the bottom of the log splitter beam assembly. The tank assembly is also turned around so that the tank assembly is furthest away from the beam assembly and the attachment points are closest.
vi. Securing the detachable mounting bracket to the bottom of the log splitter beam assembly, which allows the beam assembly to rotate about the pin through attachment points, which is not coaxial with either one of the beam assembly or the tank assembly.
vii. Removing the hold down plate to free the beam assembly from the stand.
viii. Rotating the log splitter beam assembly down until the third and fourth attachment points on the log splitter beam assembly engage the first and second attachment points on the tank assembly.

The opposite process is also important, that is, the process of loading onto the shipping stand. Obviously the loading of the device requires that it be placed onto the stand in parts, in particular:

### Assemblies on to Stand Pre-Shipping:

1. The beam assembly
2. The hitch/tank (box) assembly
3. The second wheel
4. The detachable bracket
5. Packaging, pins, etc., and
6. The shipping stand itself.
Process for Loading onto Stand:

The stand of the invention provides the needed stability during shipment.

As shown in FIGS. 4-5 and FIG. 10, a log splitter loading structure using the shipping stand comprises the loading rack and wood splitter, with the single-use hinge bracket shipped attached thereto but only used for one cycle of shipment (for disassembly onto the stand and reassembly off the stand at the destination). The wood splitter beam 12 is vertical set within the depression formed by the U-shaped frame 4, inner member 5 and B-shaped stand 1, and the end plate 13 of the wood splitter beam 12 is trapped motionless in the depression by installing the hold down plate 15 (using the hole for hold down plate 15, with the hold down plate overlapping the end plate 13).

Meanwhile the tank assembly 16 of the wood splitter is set on the higher plane formed by the two side members. The side of the tank is in contact with the limit stop plate 8. Also, the side plate 17 of the tank assembly 16 is fixed in the hole 7 for a secure pin to fasten it thereto during shipment.

Steps used during this installation process, are as follows. As shown in FIG. 5, the wood splitter is first moved to one side of the stand/rack, and the splitter beam 12 is initially aligned with the depression in the rapid loading stand/rack; the beam 12 is then raised so that the end plate 13 of the beam 12 is in contact with the depression and fits therein; then, the detachable mounting bracket 14 between the tank/hitch tongue assembly 16 and the splitter beam 12 is used to separate the beam 12 from the tank/hitch tongue assembly 16: the two attachment points on the bottom side of the beam 12 and the two on the upper side of tongue 16 are detached from one another (bolts/pins are removed), and the mounting bracket 14 has a hinge run through the aperture therein, thus forming a new temporary axis of rotation. The beam 12 is rotated up, the hitch 16 is rolled away. Hole 6 for the hold down plate 15 is used to install hold down plate 15 so as to limit the splitter beam 12 in the depression. As shown in FIG. 10, the tank assembly 16 is moved to the other side of rapid loading rack, the space between the two wheels of the tank and hitch tongue assembly 16 is aligned with the B-shaped stand of rapid loading rack; the tank assembly 16 is then raised up, and the rear plate of fuel tank of tank assembly 16 is used to contact the rapid loading rack.

Note that at this point, the top side of the hitch 16 and the top side of the beam 12 are adjacent, both vertical upon the stand. This is very different and unexpected when compared to the position of assembly (in which the bottom part of the beam 12 and the top part of the hitch 16 are attached by four attachment points (seen in the figures).

Finally, the secure pin is used to fix the side end plate 17 of fuel tank for rapid loading to complete the mounting work of the wood splitter.

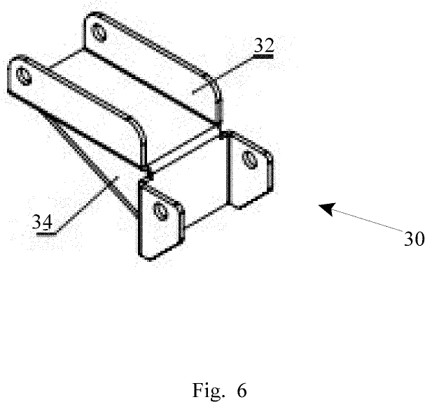

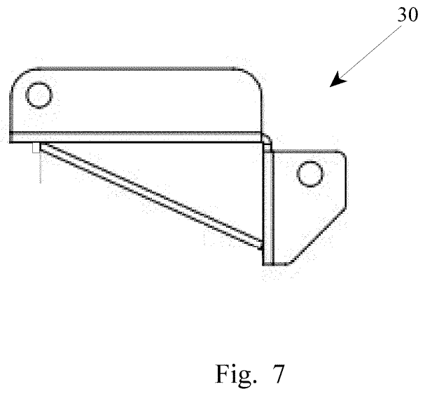

FIG. 6 is a perspective view of the fourth embodiment of the invention, the detachable mounting bracket, detached from the log splitter before or after usage, and FIG. 7 is a side view of the fourth embodiment of the invention, also detached.

The detachable mounting bracket 30 provides a second hinge point, used only once: during assembly of the log splitter by a retailer or purchaser. Thus the bracket 30 allows a single time pivot or rotation of two parts of the log splitter together, after which the two parts are connected normally by means of a permanent bracket, and the single use bracket 30 may be discarded.

Note that both the bracket 14/30 and the stand 1 may be saved and used later for maintenance, repair, etc.

Detachable mounting bracket 30 may be made out of sheet metal of heavy gauge, or other sturdy material, but it may receive structural support from being bent with flanges 32.

It may also receive structural support from diagonal support 34. Structural support is important as momentarily the entire weight of the beam assembly 12 will be on the bracket 14 during rotation.

Apertures 36 allow pins to be used to secure the bracket 14/30 to both the beam 12 and the hitch 16. The pin then becomes the axis of rotation.

Note that the attachment point on the rear end of the hitch is a bit complex, as it will attach to both the beam 12 and also, temporarily, to the bracket 14/30.

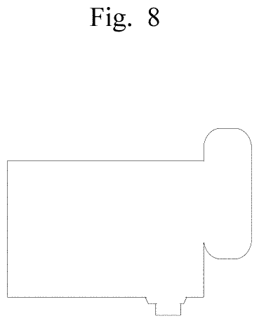

FIG. 8 is a planform view of the footprint of a log splitter, ready for shipment according to the present invention.

It is worthwhile to compare FIG. 8 to FIGS. 1 and 2. It will be instantly obvious that the footprint has become much smaller, and has been rationalized to an almost rectangular shape which fills space efficiently. Compared to a log splitter simply rotated vertically, two or three partially disassembled units of the invention may be shipped. But despite the efficient packing, this method has been found to allow FASTER assembly by the user.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A packaged log splitter comprising:
first and second wheels;
a tank assembly having a hitch tongue and a box member having first and second ends, the first wheel attached to the first end of the box member, the hitch tongue attached to the box member and extending therefrom at an angle of 90 degrees, the tank assembly having a top part;
the second wheel removably attached to the hitch tongue;
an engine attached to the tank assembly;
first and second attachment points on the tank assembly;
a log splitter beam assembly having a log splitter beam having first and second ends and an end plate attached to the first end, and further having a hydraulic cylinder attached to the second end, the log splitter beam having third and fourth attachment points on a bottom part, the log splitter beam assembly further having a top part;
a shipping stand having a plurality of vertical members, supporting first and second side members and first and second upper cross bars so as to form a generally rectangular shape, the tank assembly and the log splitter beam assembly supported upon the shipping stand with the first wheel extending beyond the first side member;
the tank assembly and the log splitter beam assembly supported elevated upon the shipping stand with their respective top parts adjoining;
a detachable mounting bracket removably secured to the packaged log splitter.

2. The packaged log splitter of claim 1, wherein the shipping stand further comprises:
a third upper inner member disposed between the first and second upper side members, the first and second upper side members and the third upper inner member defining a first plane;
first and second short vertical members connecting the third upper inner member to the first and second cross bars;
a stop extending from a first end of the third upper inner member, in the first plane but parallel to and disposed above the first cross-bar, the stop attached to the first cross-bar;
the first and second cross-bars defining a second plane;
a U-shaped body attached at a first end to the first upper side member and at a second end to the third upper inner member, the U-shaped body disposed below the first upper side member and the third upper inner member;
first and second vertical limit stop plates disposed upon the respective first and second upper side members, the first and second vertical limit stop plates projecting upward;
the end plate of the log splitter beam assembly resting on the U-shaped member and in between the first upper side member and the third upper inner member;
the tank assembly resting upon the first and second upper side members and the third upper inner member with the box assembly against the first and second vertical limit stop plates.

3. The packaged log splitter of claim 2, further comprising:
first and second apertures passing horizontally through the first and second upper side members;
third and fourth apertures passing vertically through the first and second upper side members;
a fifth aperture passing vertically through the third upper inner member.

4. The packaged log splitter of claim 3, further comprising:
a hold down plate having a sixth aperture therethrough, the hold down plate secured to the third upper inner member by a fastener passing through both the hold down plate and the third upper inner member;
the end plate of the log splitter beam assembly removably fastened to the shipping stand by the hold down plate.

5. The packaged log splitter of claim 4, wherein the box assembly is removably attached to the shipping stand by a plurality of pins passing through first and second apertures of the first and second upper side members.

6. The packaged log splitter of claim 5, the detachable mounting bracket further comprising:
first and second apertures therethrough and a diagonal support;
the detachable mounting bracket and the first aperture of the detachable mounting bracket being dimensioned and configured to engage to the first attachment point on the bottom of the log splitter beam assembly by means of a second fastener passing through both the first attachment point and the first aperture of the detachable mounting bracket, when the tank assembly is detached from the shipping stand by removal of the plurality of pins and then removed from the shipping stand and brought adjacent to the bottom of the log splitter beam assembly;
the second aperture of the detachable mounting bracket being dimensioned and configured to act as a hinge allowing rotation of the bottom of the log splitter beam assembly downward to the top of the tank assembly when the detachable mounting bracket is engaged to the first attachment point on the bottom of the log splitter beam assembly;
the third and fourth attachment points on the bottom of the log splitter beam assembly being dimensioned and configured to engage respectively to the first and second attachment points on the top of the tank assembly.

7. A method of unpackaging and assembling the log splitter of claim 6 comprising the steps of:
i. Removing a packaging material from the packaged log splitter;
ii. Detaching the second wheel from the packaged log splitter and attaching it to the second end of the box assembly;
iii. Detaching the tank assembly from the shipping stand by removal of the plurality of pins;
iv. Rotating the tank assembly to a horizontal position, thus removing it from the stand;
v. Rolling the tank assembly about the stand and bringing the tank assembly adjacent to the bottom of the log splitter beam assembly;
vi. Securing the detachable mounting bracket to the bottom of the log splitter beam;
vii. Removing the hold down plate; and
viii. Rotating the log splitter beam assembly down until the third and fourth attachment points on the log splitter beam assembly engage the first and second attachment points on the tank assembly.
